(19) United States
(12) Patent Application Publication
(10) Pub. No.: US 2008/0252445 A1
(43) Pub. Date: Oct. 16, 2008

(54) Dynamically Configurable Wireless Sensor Networks

(75) Inventor: Paul T. Kolen, Encinitas, CA (US)

Correspondence Address: FISH & RICHARDSON, PC, P.O. BOX 1022, MINNEAPOLIS, MN, 55440-1022, US

(73) Assignee: MAGNETO INERTIAL SENSING TECHNOLOGY, INC., Carlsbad, CA (US)

(21) Appl. No.: 12/098,394

(22) Filed: Apr. 4, 2008

Related U.S. Application Data
(60) Provisional application No. 60/910,143, filed on Apr. 4, 2007.

(51) Int. Cl. G08B 1/08; G08B 23/00

(52) U.S. Cl. 340/539.16; 340/573.1

(57) ABSTRACT

Techniques, apparatus and wireless sensing networks for using wireless sensor modules positioned at different locations to obtain data of a person, an object or a premise and to form a dynamically configurable wireless sensing network where each wireless sensor module is wirelessly connected to the network and can be automatically added to or removed from the wireless sensing network.

This application claims the benefit of U.S. Provisional Application No. 60/910,143 entitled “Dynamically Configurable Wireless Sensor Networks” and filed on Apr. 4, 2007, which is incorporated by reference as part of the specification of this application.

### BACKGROUND

This application relates to sensors and sensing techniques, including sensing motion of an object, a person or an animal.

Two or more sensors can be used to interact with a person or object to obtain data from the person or object. The different sensors may be placed at different locations of the person or object to obtain data at the different locations. In some applications, the different sensors attached to a person or an object may be of the same type to measure a particular parameter of the person or object. For example, each of the multiple sensors may be a motion sensor so that the multiple sensors measure motion of different locations of the person or object.

### SUMMARY

In one aspect, this application describes, among others, techniques, apparatus and systems for using wireless sensor modules positioned at different locations to obtain data of a person, an object or a premise and to form a dynamically configurable wireless sensing network where each wireless sensor module is wirelessly connected to the network and can be automatically added to or removed from the wireless sensing network. Each wireless sensor module can include at least one sensing unit for obtaining data and a wireless transceiver for wirelessly communicating with the network. A master controller can be included in the wireless sensing network to wirelessly communicate with wireless sensor modules and to control registration of each wireless sensor module in the wireless sensing network. The master controller can be used to collect the data from the wireless sensor modules via wireless communications for subsequent data processing and operations using the collected data. In some applications, the master controller may further function as a communication hub to communicate the collected data to a destination via a communication link or network outside the wireless sensing network.

In another aspect, a sensor system can include a sensor operable to measure a parameter in connection with a body part of a person and to wirelessly transmit the measured parameter; and a master controller operable to wirelessly communicate with the sensor and to collect data of the measured parameter received from the sensor. The master controller is operable to assign an communication period for communicating with the sensor and at least another communication period for communicating with at least another sensor operable to measure the parameter or a different parameter associated with the person. In this system, the master controller is operable to wirelessly communicate with the sensor and the other sensor to determine an operating status of each sensor and to terminate or activate wireless communication with a particular sensor based on the operating status of the particular sensor.

In another aspect, a method is described to include providing a master controller to wirelessly communicate with one or more sensors each of which is operable to sense a parameter of a person and wirelessly sends measured data to the master controller; configuring the master controller and each sensor to form a dynamically reconfigurable wireless network wherein each sensor is operable to automatically join and leave the network; configuring the master controller to supply a normal profile related to measurements from the one or more sensors; and operating the master controller to compare a real-time profile from received measurements from the one or more sensors to the normal profile to generate an alert signal when the real-time profile deviates from the normal profile.

These and other aspects, examples, implementations, and variations of the techniques, apparatus and systems are described in greater detail in the attached drawings, the detailed description and the claims.

### BRIEF DESCRIPTION OF DRAWINGS

FIG. 1 illustrates an example dynamically configurable wireless sensing network.

FIG. 2 shows an application of the dynamically configurable wireless sensing network where wireless sensor modules are attached to a person and a piece of equipment used by the person.

FIGS. 3A and 3B show an example operation of the master controller for the dynamically configurable wireless sensing network in FIG. 1.

FIGS. 4A and 4B show an example operation of a slave sensor module associated with the operation of the master controller in FIGS. 3A and 3B for the dynamically configurable wireless sensing network in FIG. 1.

### DETAILED DESCRIPTION

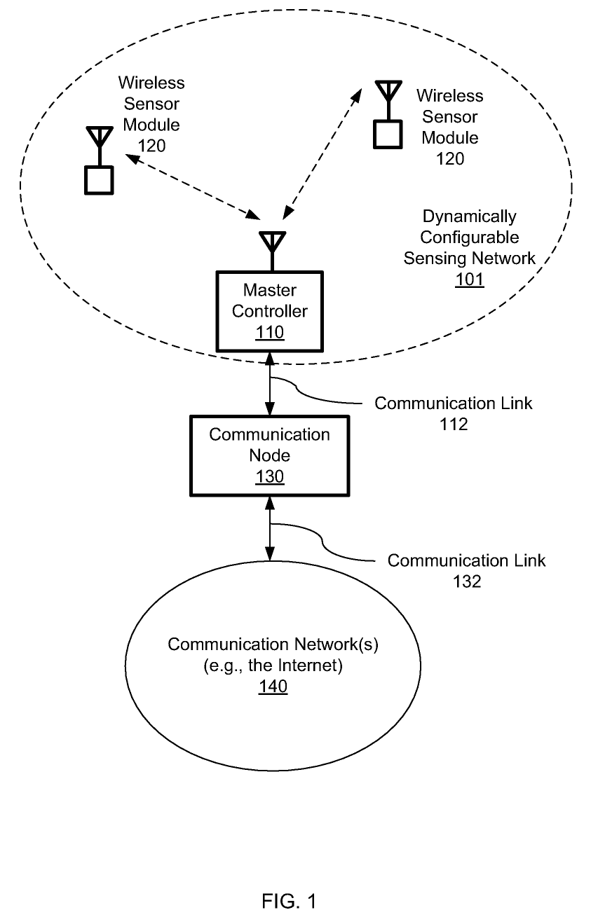

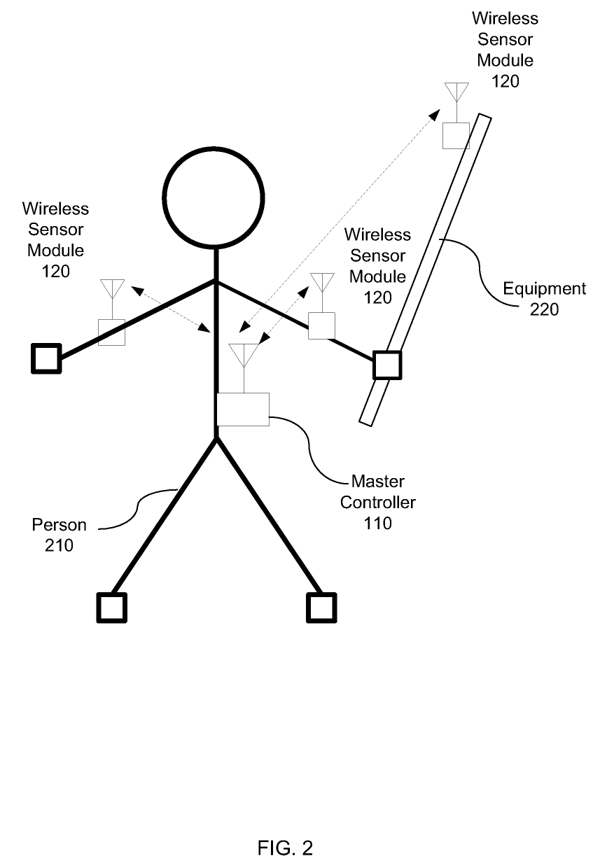

The dynamically configurable wireless sensing network 101 in FIG. 1 includes a master controller 110 and one or more wireless sensor modules 120 positioned at different locations to obtain data of a person, an object or a premise. As an example, FIG. 2 shows an application of the dynamically configurable wireless sensing network 101 in FIG. 1 where wireless sensor modules 120 and the master controllers 110 are attached to a person 210 and a piece of equipment 220 used by the person 210. The wireless sensor modules 120 and the master controllers 110 can include motion sensors so that the motion of the different body parts of the person 210 and the equipment 220 can be monitored by the wireless sensing network.

In the example in FIG. 1, each wireless sensor module 120 can include at least one sensing unit for obtaining data, a wireless transceiver for wirelessly communicating with the wireless sensing network 101, and a portable power supply such as a battery to supply power to various components within the sensor module 120. The wireless communication between each sensor module 120 and the wireless sensing network 101 may be achieved via the master controller 110. Each wireless sensor module 120 can include a micro-processor or micro-controller that controls the operations of the sensor module 120, including sending sensor data to the wireless sensing network 101.

The master controller 110 includes a wireless transceiver to wirelessly communicate with each wireless sensor module 120 and can operate to control registration of each wireless sensor module 120 in the wireless sensing network 101. The master controller 110 can be used to collect the data from each wireless sensor module 120 via wireless communications for subsequent data processing and operations using the collected data. The master controller 110 can include a micro-processor or micro-controller that controls the operations of the master controller 110. The master controller 110 may also include at least one sensing unit as another sensor module for obtaining data of the person, the object or the premise covered by the wireless sensing network 101. The master controller 110 may use either a portable power supply in some implementations or a power supply connected to the power grid by a power cable in other implementations.

In one implementation, the master controller 110 can be battery powered if it is mounted on an moving object such as a person. In this case, the master controller 110 may include a sensor. If the master controller 110 is fixed at a location, the power source for the master controller 110 can be either battery or line powered.

Each sensor module 120 and the master controller 110 can be programmed to form a dynamically configurable wireless sensing network where a wireless sensor module 120 can be automatically added to or removed from the wireless sensing network 101 based on wirelessly communications with the master controller 110. The communications between each sensor module 120 and the master controller 110 can be achieved by direct communications where each sensor module 120 directly communicates with the master controller 110 and data from each sensor module 120 is not relayed to the master controller 110 via another sensor module 120. Alternatively, the communications between each sensor module 120 and the master controller 110 can be achieved by both direct communications and by indirect communications via one or more other sensor modules 120 as the intermediate nodes where a sensor module 120 that is too far away from the master controller 110 may first send the data to an adjacent sensor module as a relay station for forwarding the data to the master controller 110.

Each sensor module 120 can incorporate both hardware and software protocol to allow the sensor module 120 to become integrated into the wireless sensing network 101 controlled by a master controller 110. Once a new sensor module 120 is turned on to operate, the sensor module 120 can be programmed to initiate a search for the master controller 110 on by emitting a search beacon at a default RF frequency. If the new sensor module 120 is detected by the master controller 110, the master controller 110 can be programmed to acknowledge and assign the new sensor module 120 the information required for network integration via the default RF channel. The master controller can send out configuration data to each sensor module 120 and, once the new sensor module 120 acknowledges the receipt of the configuration data, the new sensor module 120 becomes admitted and integrated into the wireless sensing network 101. In the example described below, a new RF channel is assigned to the newly admitted sensor module 120 for subsequent wireless communications with the master controller 110 at a given time slot. Once integrated into the wireless sensing network 101, the new sensor module 120 can send information regarding the module function and data format to allow the master controller 110 to integrate the new sensor module 120 into the overall sensor scanning sequence performed by the master controller 110 to sequentially scan the active sensor modules 120 in the network 101, data storage, and packet formatting in the wireless sensing network 101.

If any of the acknowledged sensor modules 120 in the wireless sensing network 101 is physically removed, not needed in a sensing application, out of power due to a drained battery or other device failure, or fails to respond to the master controller 110, the master controller 110 can operate to remove the missing sensor module 120 from the scan sequence, data storage, and packet formatting. The detection of the missing sensing module 120 can be achieved by noting the absence of the expected communication on the allocated time slot for that sensor module 120 on the assigned communication RF channel. When no communication has been detected by the master controller 110 for over a pre-determined time-out period, the master controller 110 can initiates a process for removing the missing sensor module 120.

In some applications, the master controller 110 may be configured to further function as a communication hub to communicate the collected data to a destination via a communication link or network outside the wireless sensing network 101. In FIG. 1, a communication node 130 is shown to connect the master controller 110 to a communication network 140 such as the Internet through which the collected data from the wireless sensing network 101 can be remotely accessed. The communication link 112 between the master controller 110 and the node 130 can be a wireless communication channel or a wired communication channel. The communication node may be a computer or other device. The communication link 132 between the node 130 and the network 140 may be a wired or wireless communication channel.

In some applications, the master controller 110 can use the scanned sensor data locally by processing the collected sensor data. In other applications, the master controller 110 can re-format and resend the sensor module data to the node or external device 130, i.e. a PC running a specific application program, to allow additional data analysis or manipulation.

The following describes one implementation of the communication protocols between the master controller 110 and a sensor module 120 as a slave for the dynamically configurable wireless sensing network 101 in FIG. 1.

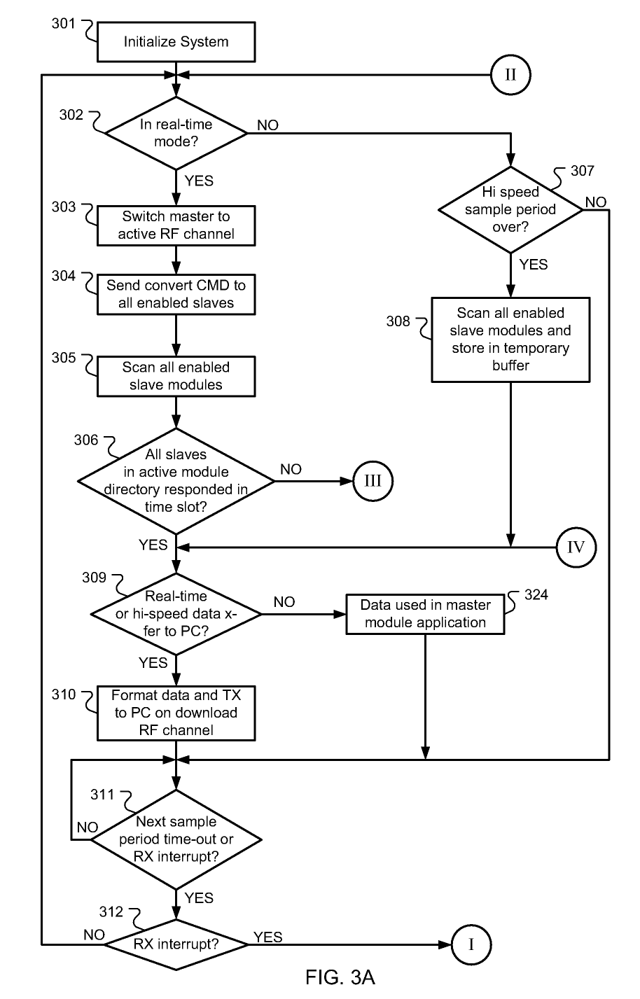

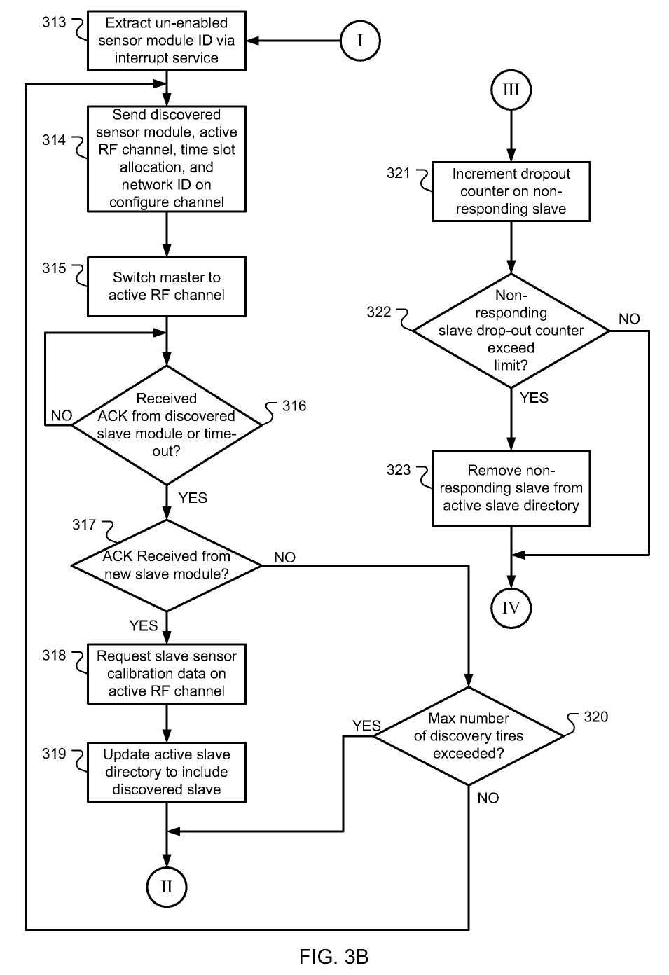

FIGS. 3A and 3B describe an example of operations of the master controller 110.

1) Initialization Step 301. Once turned on, the microprocessor or microcontroller inside the master controller 110 initializes internal resources, i.e. a Universal Asynchronous Receiver-Transmitter (UART) that translates between parallel bits of data and serial bits, the direction of I/O control lines, and other hardware configurations. After the initialization, the information on the external resources such as sensor power management, RF addresses, and data packet formats are sent to the RF transceiver within the master controller for communications with each slave sensor module 120. The microprocessor jumps into the main program loop once complete.

2) Selection of an operation mode 302. There can be two modes of operation, the real-time mode and a high-speed mode. In the real-time mode, the data from each enabled slave sensor module 120 is scanned by the master controller 110 every sample period shown in steps 303, 304, 305 and 306. In the high-speed mode, the data collection rate from the sensor modules 120 can be too fast for the real-time transfer and thus multiple sensor scans are stored on the slave sensor module 120 at a predetermined scan rate for later bulk transfer to the master controller 110 as shown by steps 307 and 308.

3) At step 303, the master controller 110 is switched to an active RF channel to communicate with all enabled slave sensor modules 120 present in the network 101.

4) At step 304, the master controller 110 sends a convert command to all enabled slave sensor modules 120 to scan their respective sensor arrays where each sensor module 120 may include one or more sensors, e.g., three accelerometers, three magnetometers, and three gyroscopes in a motion sensor module.

5) At step 305, the master controller 110 waits in a receive mode in active RF channel waiting for all enabled slave sensor modules 120 to respond with the last sensor scan in a respective assigned time slot. This access by multiple sensors in the time domain over a channel is known as time delay multiple access or TDMA where a unique time delay for each enabled slave sensor module 120 is assigned for communicating with the master controller 110. Each slave sensor module 120 waits for this time delay before it tries to transmit to the master controller 110 after receipt of the convert command sent to all slave sensor modules 120, e.g., simultaneously. This operation prevents the individual slave sensor modules 120 from trying to communicate with the master controller 110 at the same time on the same active RF channel which can cause loses of data packets. Each delay is determined by the time needed for all the sequential slave sensor modules 120 to complete their respective data transfer.

6) At step 306, the master controller 110 determines whether all enabled slave sensor modules 120 responded in their assigned time slots. If not, the master controller 110 proceeds to step 319. Otherwise, the master controller 110 executes the step 309.

7) At step 307 for the high-speed mode, the master controller 110 determines whether the scan period is over, e.g., whether a scan period of 5 seconds has passed. If yes, the master controller 110 proceeds to step 308. Otherwise, the step 311 is executed with no action taken.

8) At step 308, if the scan period is over, each slave sensor module 120 has stored multiple samples in its internal memory, i.e. 5 seconds at 20 samples/sec=100 stored sensor scans, over the scan period. At the end of the scan period, the master controller 110 sends a data dump command to all enabled slave sensor modules 120 to request transfer of the stored sensor data. In response, each enabled slave sensor module 120 can sequentially download the stored data to the master controller 110 when individually requested by the master controller 110. The TDMA scheme may not be used in this download by the sensor modules 120 because the download is not in real-time. The master controller 110, upon receiving the downloaded sensor data, can assemble all the stored scans received from all enabled slave sensor modules 120 into a temporary buffer for internal use or re-transmission to a PC for use in a PC application program.

9) At step 309, the master controller 110 determines whether the application using data stream is running locally on the master controller 110 or requires re-transmission (TX) to the PC 120 for a PC application and steps 310 and 324 are respectively executed accordingly.

10) At step 310, if re-transmission by the master controller 110 to the PC 130 is needed due to the PC application, the real-time or hi-speed mode data scanned from each enabled slave sensor module 120 can be formatted and downloaded to a PC on a designated download RF channel.

11) At step 311, the master RF transceiver is switched to the receive mode (RX) on the default discover RF channel after the current real-time or hi-speed data scan is completed. All slave sensor modules 120 can use this RF channel to announce their presence to the master controller 110. In the RX mode, the main program loop waits for the next scan period to time-out OR receive an interrupt generated by the receipt of a RX on the slave discovery channel. If neither a time-out or RX interrupt is generated, the program continues to wait. If either event occurs, the master controller 110 proceeds to step 312.

12) At step 312, the master controller 310 determines whether a time-out OR RX interrupt causes the main program to leave the step 311. If a time-out causes the event, the master controller 310 proceeds to step 3022, the start of the main program loop. If a RX interrupt causes the event, the master controller 110 proceeds to step 313.

13) At step 313, a RX interrupt is generated by a new slave sensor module 120 on the default discover RF channel. Within the received data packet from the new slave senor module 120 is the device ID. The master controller 110 proceeds to step 314.

14) At step 314, the received device ID allows the master controller 110 to determine what function the new slave sensor module 120 is to perform, e.g., motion sensing by a motion sensor module or a temperature sensor. This information allows the master controller 110 to assign a delay and time slot long enough to allow receipt of the expected data stream per scan from this new slave sensor module 120. The RX from the current slave is completed before the next sequential slave attempts to RX to the master as described the above TDMA communication.

From this information, the master controller 110 sends the newly discovered, and now enabled, slave sensor module 120 the current active RF channel used by the master controller 110, the TDMA time delay, and local network ID. This network ID, different from the device ID, allows the master controller 110 to communicate to all slaves simultaneously, i.e. common convert command, or to a single slave individually, i.e. download stored calibration data from slave module EEPROM. Next, the step 315 is executed.

15) At step 315, after the configuration data is sent to the new slave sensor module 120, the master controller 110 switches to the active RF channel and then proceeds to step 316.

16) At step 316, the master controller 110, now in the active RF channel, waits to receive an acknowledgement (ACK) from the newly enabled slave sensor module 120 on the active RF channel OR a time-out. If either occurs, the master controller 110 proceeds to step 317.

17) At step 317, when an ACK causes the exit in step 316, the master controller 120 proceeds to step 318. If a time-out is the cause for the exit, the master controller 110 proceeds to step 320.

18) At step 318, an ACK is received by the discovered slave sensor module 120. The master controller 110 sends a request for the slave sensor module calibration data to be sent on the active RF channel if applicable. The master controller 120 next proceeds to step 319.

19) At step 319, the active slave directory in the master controller 110 is updated to allow subsequent slave sensor module scans to include the newly discovered slave. The master controller 120 proceeds back to the start of the main program loop at step 302.

20) At step 320, if a time-out is the cause of jumping out of the step 316, the master controller 110 determines whether the number of attempts to receive an ACK from the new slave sensor module has exceeded a pre-set limit. If the limit is exceeded, the master controller 110 discontinues the process ignoring the problematic slave and proceeds back to the start of the main program loop at step 302 without including the errant slave into the active slave directory. If the limit is not exceeded, the master controller 110 is set back in the discover RF channel and proceeds to step 314 to re-establish communication with the new slave.

21) Step 321 is executed as a result of a false result in step 306, i.e. not all active slave sensor modules responded in the allotted time slot. A missed communication counter (MCC) is kept for all slave sensor modules in the active slave directory within the master controller 110. The MCC counter for each slave module not communicating on this scan period is incremented. Next, step 322 is executed.

22) At step 322, the master controller 110 checks whether the MCC of any of the active slave sensor module has exceeded the limit. If so, the master controller 110 proceeds to step 323. Otherwise, the master controller 110 goes back to the main program loop at step 309.

23) At step 323, one or more of the active slaves have exceeded the MCC limit. These devices can be presumed to be turned off and/or removed from the local network. These devices are then removed from the active slave directory of the master controller 110 and are no longer scanned. Once the directory is updated, the master controller 110 goes back to the main program loop at step 309.

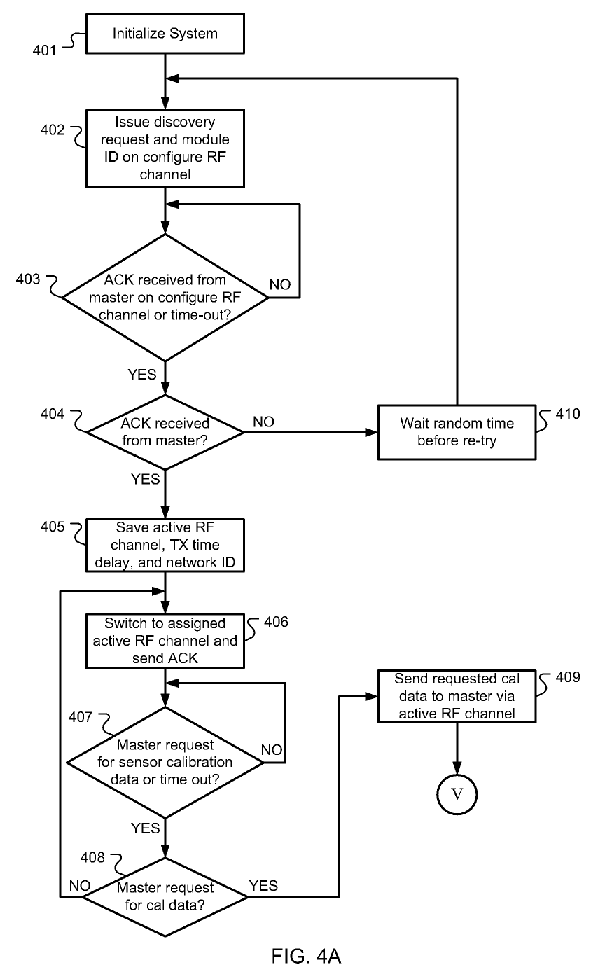

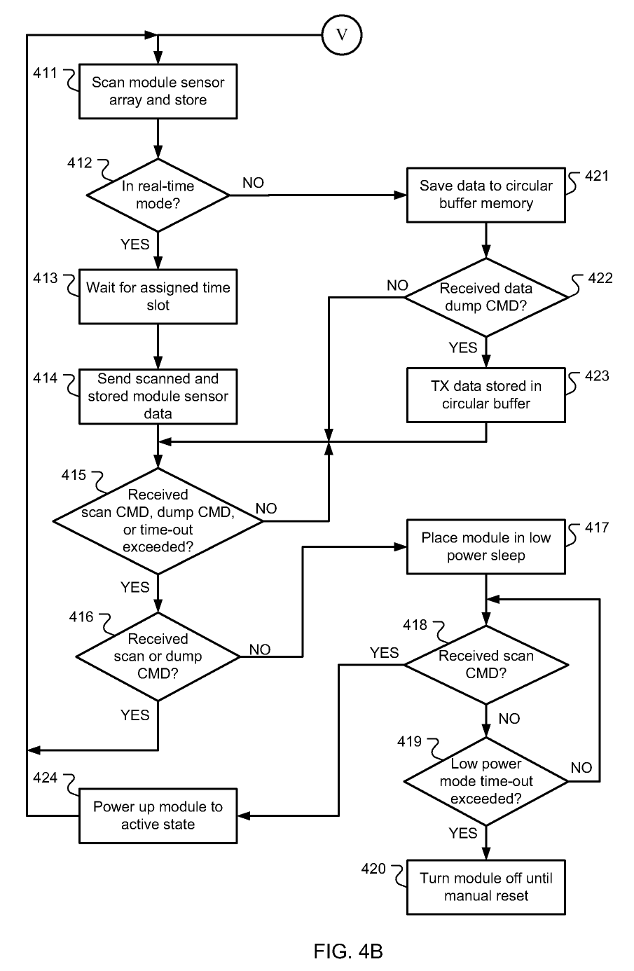

FIGS. 4A and 4B describe operations of each slave sensor module 120 in the wireless sensing network 101 in FIG. 1 based on the operations of the master controller 110 in FIGS. 3A and 3B.

1) At step 401, the slave sensor module 120 is turned on and the microprocessor or controller inside the slave initializes internal resources, i.e. UART, direction of I/O control lines, etc. Once done, external resources such as sensor power management, RF addresses, and data packet formats are sent to the RF transceiver. The microprocessor jumps into the main program loop once complete.

2) At step 402, the slave module is turned on or manually reset. At this time, the slave module begins to transmit (TX) a discover request on the default configure RF channel. The slave TX includes the slave module ID to identify itself to the master module to allow the required time allocation and calibration download to be completed once enabled.

3) At step 403, the slave module waits until either an ACK is received from the master module on the configure RF channel OR a time-out. If either occurs go to step 404, if neither occurs, the slave continues to wait.

4) At step 404, the slave goes to step 405 when an ACK causes the end of step 403 and to step 407 when a time-out causes the end of the step 403.

5) At step 405, each slave receives from the master module an ACK that contains the active RF channel, the time delay for the TDMA communication, and a network ID. The received data is stored in the slave.

6) At step 406, each slave switches to an assigned active RF channel and sends an ACK to the master module.

7) At step 407, each slave waits until RX from the master module for calibration data on active RF channel or time-out. When ether occurs, the slave proceeds to step 407.

8) At step 408, if master RX causes the ending of step 407, the slave sends calibration data to the master on the assigned active RF channel and then goes to step 409. If time-out causes the ending of step 407, the slave goes to step 406 to re-try ACK to the master.

9) At step 409, each slave sends calibration to the master module on active RF channel and proceeds to step 411.

10) If the master ACK on configure RF channel is not received before the time-out, the slave waits for a random time-out before a re-try and then proceeds to step 402 to re-issue a discovery request to the master on the configure RF channel.

11) Step 411 is the start of the main sensor scan loop. The slave module sensor array is scanned and saved.

12) At step 412, the salve determines whether the operation mode of the master is in the real-time or the high-speed mode and proceeds to step 413 when the master in the real time mode and to step 418 when the master is the high-speed mode.

13) At step 413, after the sensor scan, the slave waits for the delay period before transmission to the master module due to being in TDMA mode. Next, the step 414 is executed.

14) At step 414, the slave transmits the scanned data to the master module on the active RF channel.

15) At step 415, the slave waits for receipt of a scan command or dump command from the master OR waits for the time-out. When any of these occurs, the slave goes to step 416.

16) At step 416, the slave proceeds to top of the scan loop routine at step 411 when the receipt of a scan command or dump command from the master causes the ending of the step 415. When the time-out causes the ending of the step 415, the slave goes to step 417.

17) At step 417, the slave enters a low power mode but remains active waiting for a command from the master. During this period, the communication with the master module is either suspended or lost.

18) At step 418, the slave determines if while in the low power wait loop, a command is received from the master on the active RF channel. If yes, the slave goes to step 424. If no, the slave goes to step 419.

19) At step 419, the slave further determines whether the low power wait period has been exceeded and goes to step 20 when the wait period has been exceeded. Otherwise, the slave continues to wait as in step 418.

20) At step 420, the low power wait loop time is exceeded without receiving a command from the master (e.g., the master is turned off or out of range or not working) and the slave in set into an “OFF” state requiring manual restart to save battery.

21) At step 421, the slave operates in the hi-speed mode at step 412 and saves the current sensor scan data in a local memory and proceed to step 422.

22) At step 422, the slave determines whether the last received master command is a dump command. If yes, the slave goes to step 423. Otherwise, the slave goes to step 415 and waits for the next received command from the master.

23) At step 423 when a dump command is received in the last reception from the master, the slave formats and transmits data to the master module. Upon transmission, the slave clears the local buffer to prepare for next hi-speed data save and proceeds to step 415 for the next reception from the master.

24) At step 424, the slave receives a command from the master while in the low power mode, and, in response, the slave powers up the sensor array to begin the next sensor scan by going to step 411.

Referring to the dynamically configurable wireless sensing network 101 in FIG. 1, the sensor modules 120 may be implemented in various configurations for various applications. One example is dynamically configurable wireless motion sensing network attached to a person or an object to monitor the motion of various parts of the person or object. Each motion sensor module can be implemented in the configurations described in U.S. Pat. No. 7,219,033 entitled “Single/Multiple Axes Six Degrees of Freedom (6 DOF) Inertial Motion Capture System with Initial Orientation Determination Capability”, which is incorporated by reference as part of the specification of this application.

As a specific example for the application of the dynamically configurable wireless sensing network 101 in FIG. 1, the following describes an adaptable RF networked dynamic and static Inertial-Magnetic Motion Capture (IMMCAP) system.

Motion of an object can be monitored using various sensors. For example, an accelerometer can be attached to the object to be monitored to measure the acceleration of the object. For another example, a gyroscope sensor can be attached to the object to measure the orientation of the object. A tri-axial accelerometer that measures acceleration in three directions (e.g., three one-dimensional accelerometers in three orthogonal directions x, y and z) and a gyroscope inertial navigation system (INS) can be combined to construct an inertial measurement unit (IMU) capable of determining the change in the spatial orientation and the linear translation of the object relative to a fixed external coordinate system. A tri-axial magnetometer may be added to this IMU system to measure the orientation of the IMU relative to the earth magnetic field and thus determine the absolute orientation of the IMU.

In some implementations, a magnetometer can be used as a differential rotation rate sensor capable of measuring high rates of rotation about all three magnetic axes that may be difficult for gyro-based rate sensors to measure due to limitations in gyro-based rate sensors. These high rates of rotation exceed the dynamic range of currently available gyros. This magnetic sensor based rotation rate sensor can be used in conjunction with the gyros OR be a substitute for the gyros when the gyro capabilities are known to be exceeded and the local external ambient earth magnetic field is known to be constant or at least quasi-constant. Certain aspects of magnetometer rate sensors are described in U.S. Pat. No. 7,219,033.

A single master IMMCAP® controller module (ICM) can be implemented as the master controller 110 in FIG. 1 and is RF-linked to an array of one or multiple IMMCAP® sensor modules (ISM) as the wireless sensor modules in FIG. 1. The microprocessors or micro controllers in the ICM and ISMs can be programmed as described above to form a dynamically configurable RF network called an RF-BioNet. In applications that require data display and/or analysis via a PC based software application, the ICM can interface with a PC via a standard USB interface for data down/up loading and system configuration.

The single ICM can include, e.g., a six degree-of-freedom (6 DOF) IMMCAP® motion capture sensor together with the required digital signal processing (DSP), RF transceiver to support bi-directional communications to the single or multiple ISMs via the 2.5 GHz ISM band, a human interface, i.e. input keypad and LCD screen, and a USB interface for PC connectivity. The software installed into the ICM will be highly dependent on the actual application intended for the IMMCAP® based system.

The single or multiple ISMs can include a low power microcontroller (μC), an ISM band RF transceiver, a battery based power supply, and an IMMCAP® sensor array appropriate to the intended application. The aforementioned sensor array can include a simple static orientation sensor, i.e., a single tri-axial accelerometer, up to a fully capable 6 DOF configuration including a tri-axial accelerometer, tri-axial rate sensor, and a tri-axial magnetometer.

The single ICM and each ISMs are interfaced via a bi-directional RF interface scheme referred to as RF-BioNet®. As described above, this interface scheme allows an ISM to be added or removed from the RF-BioNet® controlled by the local ICM without intervention by the user. This scheme is functionally similar to the “Plug and Play” feature of a computer under the Microsoft's Windows Operating System where hardware, i.e., any USB device like a memory stick or digital camera, can be automatically detected, identified, and configured by the computer after the Windows Operating System detects the physical connection of the USB device. Hence, any ISM added or removed from an operating RF-BioNet® can be transparently integrated into the local RF network allowing the added/removed ISM sensor data to be collected/deleted and integrated into the real-time composite data stream for local use by the ICM or streaming to a PC for real-time or post-analysis applications.

The integration of an application specific software for the network protocol described above with reference to the examples in FIGS. 3A, 3B, 4A and 4B, static or dynamic motion capture applications can be realized via a sensing system shown in FIG. 1 with little to no modification of the base system save the application software. This easily re-configured system allows for a license or OEM type business model applicable to many industries and end applications requiring some form of motion capture information.

The above described sensing systems are using wireless sensor modules without power or interface wires that are physically connected to the individual sensor module and allow for dynamic modification of the sensor modules in the systems. The capabilities of the IMMCAP based motion capture system allow the systems be used in various motion capture applications currently implemented by either video or magnetic beacon based systems. However, these systems may require that the person or object to be monitored must be confined within a pre-described local volume of space or within the optical or artificial magnetic field of view to be useful. The use of the IMMCAP based motion capture system removes these limitations. The implementations of the present systems are simple and easy to use and can be achieved at a relatively low cost by using, e.g., low cost and compact inertial MEMS based sensors. Users can apply the present systems to specific user applications without the need for users' technical ability or resources to design their own hardware/software systems to get into their target market quickly in a cost-effective manner by licensing or an OEM arrangement.

In some implementations, the majority of the digital signal processing (DSP) including data formatting and the communication protocols between the master and slave as shown in FIGS. 3A, 3B, 4A and 4B can be implemented in the microprocessor or microcontroller of the master ICM and each ISM to minimize the cost, the unit size and mass, and complexity of the sensing system. The data that is transmitted in the sensing network can be limited to the sensor data stream required for a specific application with the associated minimum amount of RF/DSP/power requirements to allow integration into the RF-BioNet®.

The IMMCAP® Control Module (ICM) is the master controller within the IMMCAP® based motion capture system and acts as the RF hub for the local RF-BioNet®. The ICM controls all the bidirectional RF traffic on the RF-BioNet® between the single or multiple ISMs and the single ICM itself. The ICM may use an 8-16, or 32 bit microprocessor capable of providing all the real-time DSP for any given application. Additionally, the ICM can be used to provide data acquisition tasks associated with the ISMs including sensor linearization and temperature compensation. In addition to the above tasks, the ICM can also incorporate some form of IMU to allow motion capture of the rigid body the ICM is attached to if needed.

For example, the ICM may include 1) 8/16/32 bit microprocessor, 2) a battery power source such as a lithium ion battery, 3) a power conditioning circuit for digital and analog (if present) circuitry, 4) a recharging mechanism via USB connection and/or external power source, 5) an ISM band transceiver capable of agile frequency hopping and simultaneous multi-frequency operation in communicating with an ISM, 6) a human interface, i.e. keypad and LCD in some applications, 7) a motion sensor to implement some form of IMMCAP® IMU if required by specific application, and 8) application specific software to run on the microprocessor. The ICM can be packaged in an ICM case that can be attached to the user waist belt or arm. The placement may be determined by the type of human interface required for the application.

An IMMCAP® Sensor Module (ISM) is the slave to the ICM and is connected to the system under the control of the ICM. The ISM can incorporate a variant of the IMMCAP® IMU which is application dependant ranging from a basic orientation sensor requiring a single tri-axial accelerometer to a full-up 6 DOF variant. An ISM regardless of the IMU variant can incorporate an 8 or 16 bit microcontroller, some form of non-volatile memory, and a frequency agile RF transceiver (e.g., a transceiver operating at the 2.5 GHz band). The RF-BioNet® protocol as described in the example in FIGS. 3A, 3B, 4A and 4B allows the individual ISM to dynamically integrate, i.e. without rebooting the system, into the RF-BioNet® to establish a bi-directional RF link with the ICM. Upon the establishment of the RF link, the ISM can transfer sensor calibration and function data to the ICM which combines the received ISM sensor data with other ISM sensor data into an ICM data stream.

As a specific example, an ISM can include 1) 8/16 bit microprocessor or microcontroller, 2) a battery power source such as a lithium battery, 3) a power conditioning mechanism for digital and analog circuitry, 4) a recharging mechanism via external power source, 5) an ISM band transceiver capable of agile frequency hopping and simultaneous multi-frequency operation, 6) a motion sensor to implement some form of IMMCAP® IMU as required by specific application, 7) software to acquire and format data from the motion sensor and to allow interfacing to the local RF-BioNet® running on the microprocessor or microcontroller. The ISM can be incorporated into an appliance with an attachment to a rigid axis the ISM is designed to monitor. For human motion and sport applications, the ISM can be attached to sport apparatus, i.e. golf shaft, baseball bat, bowling glove, etc. For human motion, the ISM can be attached directly to the body axes, i.e. hand, forearm, head, etc.

The RF-BioNet® formed by the ICM and at least one ISM is designed to allow bi-directional RF communications between the ICM and each ISM present in the signal strength range of the RF transceiver. The ICM controls communications between the ICM and each ISM and ICM-ISM communications can be initiated by either the ICM or any of the ISMs within RF range.

The ICM-ISM communications in the RF-BioNet® can be configured in two different ways. In a first configuration, each ISM directly communicates with the ICM without routing through other ISMs. Data is exchanged between the ICM and individual ISM on a RF channel dedicated to the immediate data exchange. The channel allocation is controlled by the ICM based on external RF interference due to local devices also operating in the 2.5 GHz band such as wireless LANs. Additionally, the ICM allocates channels to multiple ISMs based on the channel traffic and required response latency. Both the ICM and the ISM RF transceivers are capable of agile frequency hopping to facilitate the dynamic channel allocation.

In a second configuration, multiple ISMs are present in the RF-BioNet, e.g., multiple ISMs distributed on a large object or animal for motion capture or analysis, and the physical separation of one or more ISM from the ICM may be sufficiently large to adversely affect the quality of the wireless ICM-ISM communications. Accordingly, the RF data transfer between the nodes can be accomplished by a “daisy chain” where the RF data transfer is facilitated by an intermediate ISM physically between the two communicating nodes. This mode is more power intensive for the ISMs as theses ISM's need be maintained in the higher power receive mode all the time to “sniff” the ether for any data communication initiation. If an RF transfer is detected, any node that detects the signal responds and repeats the signal to be picked up by another ISM in range. This will continue until the RF data transfer has been acknowledged by the ISM/ICM the original signal is intended for. The direct communication between each ISM and the ICM allows each ISM to minimize the power consumption because the RF transceiver in each ISM operates only when each ISM communicates with the ICM and does not operate to relay data for other ISMs as long as the RF range of the RF transceivers allows direct communications between the two communicating nodes.

The self-configuring ability of the RF-BioNet® allows new ISMs to be added or removed without any attention by the end user. The ICM is capable of identifying the added/removed ISM and integrate/remove the data stream from the ICM composite data stream. This feature allows existing systems to be enhanced by additional ISMs without modification of the existing system.

The motion capture RF-BioNet® may be applied to specific application. One example is a monitoring system for monitoring people on a premise such as elderly and disabled persons in a hospital or nursing home. For example, a subject under monitoring can fall or become immobilized due to an accident or as a result of a medical condition. One or more motion sensor modules attached to the subject can provide motion data that indicates such a condition. Once the fall event has been detected, the condition of the subject after the fall may be further determined by the system, e.g., using a feedback mechanism to determine whether the subject is unconscious. The system may be configured to respond by generating an alert signal and calling for assistance as needed.

In implementing such a monitoring system, the center of mass of the subject can be monitored by monitoring, e.g., the motion of the pelvis or hip region, and one or more of the appendages, i.e. feet or arms. The motion of the center of the mass can be used to determine, with a high degree of accuracy, whether the subject has experienced a fall. The pelvis motion and orientation can be monitored by placing an IMMCAP® based 6 DOF inertial measurement unit (IMU) onto an appliance attached to the belt region of the subject. For example, the master controller ICM can be configured to include the 6 DOF IMU described in the U.S. Pat. No. 7,219,033 to monitor the center of mass. In addition to the ICM, one or more ISMs can be attached to the subject, e.g., the foot region, to monitor other aspects of the motion of the subject. The ISMs can be integrated into one or both shoes. Additional ISMs may be integrated into a wrist mounted appliance to further enhance the accuracy of the fall detection.

The data generated by the single or multiple ISMs attached to the subject are interfaced to the ICM via the RF-BioNet®. The composite data stream produced by all the registered ISMs are input variables into an algorithm contained in the ICM software which compares the data stream to a model of a “fall event” and a second model for a “post-fall orientation.” If by comparison to the fall event model, the real-time data stream from the ISMs indicates a high probability of a fall occurring, the post-fall model is compared to the real-time data stream. If there is a high probability that the subject is in a likely post fall orientation, the subject is interrogated by a simple acoustic message as to the subject state. If no response to the interrogation is detected, an automatic call (e.g., a 911 emergency call) is generated by using, e.g., a blue tooth cell phone interface or an alert signal is generated to an existing security system such as ADT or similar.

In addition to the automatic call, a user device may be provided to the subject for the subject to manually indicate the need for a response or assistance if the subject is conscious after the fall event or if some non-fall medical situation becomes apparent to the subject. A push-button communication device capable of generating a call in response to a push to the push button may be attached to the subject as such a user device. This device may be separate from the ICM as a stand-alone device or integrated into the ICM.

An advanced feature utilizing the motion capture/compare ability of the system is to monitor the gait and/or body movement of the subject. Due to the available high powered DSP contained in the ICM, the ICM can monitor the motion data of the subject under normal conditions of the subject and thus can “learn” the normal behavior of the subject and gait patterns of the subject from the motion data when the ICM is set into a “learning mode” for a period of time. The motion data collected during the learning mode can be used to generate a “normal model” and this normal model can again be compared to the real-time data stream from the ICM/ISMs when the system is out of the learning mode and is in the normal operating mode to monitor the motion of the subject. If a substantial deviation from the normal model in the real-time motion data stream from the ICM and ISMs is detected, an alert can be issued to a care-giver with the option that the real-time data stream can be seen and analyzed by the care-giver to determine if any additional intervention is required.

These and other features of the monitoring system can be used to automate part of the patient care services in hospitals, nursing homes and private homes and thus alleviate the demand for the man-power of limited care-givers available to care for the patients. Therefore, the monitoring system can be used to monitor more people by fewer care-givers, in both assisted living environment and private home environment, and can be implemented at a relatively low cost by a combination of low cost DSP and IMMCAP® based IMUs.

The above described system can be implemented in a variety of ways depending on the required capability of the system. In one example, a single ICM incorporating a DSP, RF transceiver, and 6 DOF motion sensor and a single ISM containing a single tri-axial accelerometer attached to a different location than the ICM may be sufficient. The data streams of the internal 6 DOF within the ICM and the data from the single ISM can be combined to detect a fall event and derive the post-fall orientation. In this simple system, the fall event can be detected by the 6 DOF IMU in the ICM according to comparison between the real-time motion data and the fall model. Once a fall condition is detected, a post-fall orientation model that incorporates the limited data from the ISM to that of the ICM data stream can in effect produce a “snapshot” of the body orientation, albeit sparse from one ISM. If the subject is not moving, detectable by the ICM/ISM, the tri-axial accelerometer acts as an orientation sensor relative to the local 1 g gravity vector. If no motion is detected from the motion data, the static orientation of the subject can be detected. Assuming the ISM is mounted on one foot of the subject, the ISM motion data can be used to determine whether the sole of the single shoe is parallel to the floor. Each shoe of the subject may be mounted with a designed ISM so that the two ISMs in the two shoes can be used to determine the relative orientations of the two feet of the subject and to verify whether a fall has occurred. This dual shoe ISM configuration is in part based on the observation that it is usually difficult for a subject who has fallen to keep both shoes parallel to the floor. This dual shoe ISM configuration can be used to produce a much higher probability of correct determination of a fall event.

The use of tri-axial accelerometers to create a “snapshot” of a static body orientation can be extended to additional ISMs attached to additional body axes. For example, least one more ISM may be mounted on a wrist to produce an even higher probability of correctly detecting a fall event. As more ISMs are integrated into the RF-BioNet®, the more accurate the static “snapshot” of the subject.

A tri-axial accelerometer in the above ISM may also be used to function as a motion detector. In this regard, when the ISM is not in motion, the three vector components of the 1 g gravity field along the three orthogonal directions are constant. This state of the accelerometer can be used to indicate that the ISM is stationary. If the three vector components of the 1 g gravity field are not constant, the ISM is indicated to be in motion. This motion detection has limited accuracy due to resultant acceleration of the associated motion and can be an effective way of determining the physical state of the subject once the fall event has been detected, i.e. a limb movement without center of mass movement would indicate the subject down but not unconscious.

A highly accurate physical model of the subject can be obtained by using multiple ISMs each incorporating both a tri-axial accelerometer and a tri-axial rate sensor. Multiple ISMs with this complement of IMMCAP® integrated into the RF-BioNet® can be used to monitor the entire or partial body axes and may be used to provide motion data in real time. The rate limits of many commercial rate sensors (e.g., approximately 600 degrees/sec for some MEMS rate sensors) are sufficient to cover typical rotational rates associated with the elderly and thus an ISM incorporating a fully capable IMMCAP® IMU with the tri-axial magnetometer working as a differential rate sensor may not be needed to supplement the MEMS rate sensor. As such, the ISM units for the system can be compact, light, and relatively inexpensive.

In some motion sensing applications, the above monitoring system can include an “RF tag” to identify the location of the subject within a larger environment such as an assisted care facility. The RF-tagged room or space would also integrate into the RF-BioNet® logging the movement of the subject and adding the location information to the request for assistance call made by the ICM. In one implementation on RF tagging for location data in ICM, a stationary transceiver is placed in a known location within the building or spatial volume of interest and has a unique ID and are spaced apart with minimal range overlap. Thus if 2 or more of these RF-tagged transceivers are in communication with the moveable IMMCAP system, the location of the IMMCAP system can be determined by simple triangulation from the known locations of the fixed transceivers with the Rf-tags.

The above RF-BioNet® monitoring system for monitoring people on a premise may also be used for detecting the onset of sudden infant death (SID) of a sleeping infant. It is known that the SID syndrome can strike a health infant with no advance signs of the condition. The syndrome results in the stoppage of breathing and ultimately death during sleep. The onset of SID is also suggested by the literature to be associated with a face-down sleeping position. Both the sleeping position and the detection of breathing stoppage can be detected by an application of the RF-BioNet® monitoring system.

As a specific example, an RF-BioNet® SID monitoring system can include at least one ISM and an ICM. The ISM can include a tri-axial accelerometer, an RF transceiver, a microcontroller and components to allow interfacing to the RF-BioNet®. This ISM can be used to monitor both sleeping position and breathing. The ISM is interconnected to an ICM base unit near the infant sleeping location via the RF-BioNet®. Once the ISM is attached to the infant via some appliance or integration into the clothing, the static orientation of the tri-axial accelerometer within the ISM can operate and provide data for determination of the infant sleeping position.

One aspect of the SID detection is the detection of SID onset by sensing the breathing stoppage of the infant. The detection of the breathing can be accomplished by monitoring the slight movement of the infant chest cavity using the same ISM tri-axial accelerometer in the ISM. The inhale and exhale sequence of the infant's diaphragm causes the chest cavity to mechanically expand and contract. The mechanical chest motion can be detected by using a highly sensitive accelerometer in the ISM that is capable of detecting the slight accelerations and de-accelerations associated with the chest cavity motion. In this aspect, the ISM is a breathing sensor. A breathing sensor based on other sensing mechanisms may also be used. The ISM accelerometer data stream is wirelessly transferred to the ICM via the RF-BioNet® and is analyzed via embedded DSP algorithms in the ICM dedicated to extracting the breathing information. If the ICM determines that the infant breathing has stopped or has strayed outside of an acceptable normal motion profile, the ICM unit can generate an alert signal to the care-giver or parent.

In another application, the sensor can be attached to a child for monitoring the child such as in a day-care center or other facilities. The child can wear an IMMCAP based sensor system and can be monitored for violent shaking or any other abusive physical activity. This information can be stored in local memory or be used to send a alert regarding the state of the child.

In some implementations, additional sensors can be integrated into the data stream received by the ICM, i.e. sound or temperature sensors, by either incorporating an additional sensor in the ISM that monitors the infant's chest motion or providing a separate ICM unit that can be enabled to be part of the RF-BioNet®. Hence, the dynamic configurability aspect of the RF-BioNet® can be used to allow any third party to design additional capability into the system under license.

The ICM can be configured to sent the alert wirelessly to a dedicated device located in a separate location via the RF-BioNet® such as the node 130 in FIG. 1. The ICM can send a RF signal to a fixed base transceiver 130 to execute some action, i.e., dialing a 911 emergency or sending a text message to a cell phone or other communication device.

The node 130 may be a blue-tooth enabled device such as a cell phone, or a computer connected to the Internet.

Similar to the elderly monitoring system, the ICM in the SID monitoring system can be configured to include a “learning” feature to give the parent or care-giver the ability “customize” the DSP algorithms to an individual infant. This feature can reduce the false fall alerts.

While this specification contains many specifics, these should not be construed as limitations on the scope of an invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination.

Only a few implementations are disclosed. However, it is understood that variations and enhancements may be made.

What is claimed is:

1. A sensor system, comprising:
a sensor operable to measure a parameter in connection with a body part of a person and to wirelessly transmit the measured parameter; and
a master controller operable to wirelessly communicate with the sensor and to collect data of the measured parameter received from the sensor,
wherein the master controller is operable to assign an communication period for communicating with the sensor and at least another communication period for communicating with at least another sensor operable to measure the parameter or a different parameter associated with the person, and wherein the master controller is operable to wirelessly communicate with the sensor and the other sensor to determine an operating status of each sensor and to terminate or activate wireless communication with a particular sensor based on the operating status of the particular sensor.

2. The system as in claim 1, wherein the master controller is operable to search for a wireless communication signal from a new sensor that is not previously in wireless communication with the master controller, and upon detecting the new sensor, is operable to allocate a new communication period for the new sensor to begin wirelessly collecting data from the new sensor.

3. The system as in claim 1, wherein the master controller is operable to monitor a wireless communication signal from the sensor, and after failure to receive detecting of the wireless communication from the new sensor, is operable to terminate collecting data from the sensor.

4. The system as in claim 1, wherein the master controller comprises a memory unit to store received data and is operable to transmit the received data in the memory device a destination.

5. The system as in claim 4, wherein the master controller is operable to transmit received data to the destination without first storing the received data in the memory unit.

6. The system as in claim 4, further comprising a computer as the destination to receive the received data from the master controller.

7. The system as in claim 1, wherein the sensor comprises a motion sensor.

8. The system as in claim 7, wherein the motion sensor comprises an inertial measurement sensor.

9. The system as in claim 7, wherein the sensor comprises a tri-axial accelerometer.

10. The system as in claim 7, wherein the sensor comprises a tri-axial gyroscope rate sensor.

11. The system as in claim 7, wherein the sensor comprises a tri-axial magnetometer.

12. The system as in claim 7, wherein the sensor comprises a magnetometer sensor as a differential rotation rate sensor.

13. The system as in claim 7, wherein the sensor further comprises a temperature sensor.

14. The system as in claim 7, wherein the sensor further comprises a breathing sensor.

15. The system as in claim 1, wherein the sensor comprises a temperature sensor.

16. The system as in claim 1, wherein the sensor comprises a breathing sensor.

17. The system as in claim 1, wherein the master controller further comprises a local sensor operable to measure the parameter or a different parameter associated with the person.

18. The system as in claim 1, wherein the master controller is configured to store a normal profile of the measured parameter and operable to compare the received data on the measured parameter to the normal profile to generate an alert signal when the received data deviates from the normal profile.

19. The system as in claim 18, wherein the sensor is a motion sensor and the parameter indicates a movement of the person, and wherein the normal profile is a movement profile of the person under a normal condition.

20. The system as in claim 19, wherein the alert signal indicates a fall of the person.

21. The system as in claim 18, wherein the master controller is operable to update the stored normal profile based on the received data over time.

22. The system as in claim 18, further comprising:
a mechanism to produce a request signal to the person requesting a response from the person when the alert signal is generated ; and
a mechanism to receive the response from the person.

23. The system as in claim 22, wherein the mechanism to produce the request signal is operable to produce an audio signal as the request signal.

24. The system as in claim 22, further comprising a location sensor attachable to the person and operable to wirelessly transmit information on a location of the location sensor to the master controller.

25. The system as in claim 18, wherein the sensor comprises a motion sensor operable to measure a movement of a chest of the person associated with breathing of the person.

26. The system as in claim 18, wherein the normal profile is a motion of a body part in playing a sport.

27. The system as in claim 26, wherein the normal profile is a motion of a body part in playing golf.

28. The system as in claim 26, wherein the normal profile is a motion of a body part in playing baseball.

29. The system as in claim 26, wherein the normal profile is a motion of a body part in playing basketball.

30. The system as in claim 26, wherein the normal profile is a motion of a body part in playing tennis.

31. A method, comprising:
providing a master controller to wirelessly communicate with one or more sensors each of which is operable to sense a parameter of a person and wirelessly sends measured data to the master controller;
configuring the master controller and each sensor to form a dynamically reconfigurable wireless network wherein each sensor is operable to automatically join and leave the network;
configuring the master controller to supply a normal profile related to measurements from the one or more sensors; and
operating the master controller to compare a real-time profile from received measurements from the one or more sensors to the normal profile to generate an alert signal when the real-time profile deviates from the normal profile.

32. The method as in claim 31, further comprising:
operating the master controller to wirelessly monitor each sensor with an established wireless communication link with the master controller periodically to determine whether each sensor is still part of the network;
when a sensor fails to send a wireless signal to the master controller within a time period, operating the master controller to terminate collecting data from the sensor.

33. The method as in claim 31, further comprising:
operating the master controller to search for a wireless signal from a new sensor which does not have an established wireless communication link with the master controller;
operating the master controller to accept the new sensor as part of the network after the wireless signal from the new sensor is received; and
further operating the master controller to begin collecting data from the new sensor.
